(19) United States
(12) Patent Application Publication
(10) Pub. No.: US 2026/0270273 A1
(43) Pub. Date: Sep. 10, 2026

(54) System And Method For Detecting Malware By Reverse Engineering Binary Data

(71) Applicant: Booz Allen Hamilton Inc., McLean, VA (US)

(72) Inventor: Dakota Eugene Palmer, Elkridge, MD (US)

(73) Assignee: Booz Allen Hamilton Inc., McLean, VA (US)

(21) Appl. No.: 19/075,372

(22) Filed: Mar. 10, 2025

(51) Int. Cl. H04L 9/40; G06F 21/53; G06F 21/55

(52) U.S. Cl. CPC H04L 63/1416; H04L 63/1491; G06F 21/53; G06F 21/554

(57) ABSTRACT

Provided are methods and systems for detecting malware in a computer network. Systems can include at least one computing node having memory storing program code for a malware detection application and a processor trace system and having a processor for identifying malware. The program code for the malware detection application, when executed by the processor, can cause the processor to receive a binary data stream; execute a processor trace on the binary data stream to dump processor trace data to the memory; identify a network attribute associated with the binary data stream based on the processor trace data; extract the network attribute from the binary data stream; generate a script for identifying and intercepting a beacon transmission used to transmit malware data, wherein the script is generated based on the network attribute; and intercept reception of the beacon transmission and malware data within the computer network.

### CROSS-REFERENCE

This U.S. Patent Application is related to U.S. Patent Application entitled “SYSTEM AND METHOD FOR DETECTING MALWARE BY REVERSE ENGINEERING BINARY DATA IN A DISTRIBUTED NETWORK” and filed under Attorney Docket No. 1003918-001159, the entire contents of which are incorporated herein by reference.

### FIELD

The subject matter disclosed relates generally to computer implementations of a reverse engineering network and automatic analysis of binary data, and, in some embodiments, to methods, systems, and non-transitory computer readable mediums encoded with program code for detecting malware within a computer network based on reverse engineering and analyzing of binary data.

### BACKGROUND INFORMATION

Typically, reverse engineering of binary files, such as malware samples, is extremely resource intensive, draining both time and computing resources for minimal progress in reverse engineering tasks, such as reverse engineering a malware sample. Additionally, specialized knowledge and skill can be required for analyzing and reverse engineering binary files, including time-intensive manual analysis of the binary files and binary data therein. Similarly, time-intensive manual testing of any potentially reverse engineered program code can consume both time and computing resource, while high quality and/or positive results cannot be achieved.

In some instances, reverse engineering binary data requires highly skilled analysts to manually analyze binary files, reconstruct functionality of the binary files, and develop tools to interact with the binary files. This process can take days or weeks per binary file, and manual analysis cannot provide a comprehensive analysis to collect all information related to the binary file. Without high quality results and efficient reverse engineering, malicious program code such as malware can evolve faster than malicious program samples can be analyzed, allowing the malicious program code to avoid detection when infiltrating a computing network.

### SUMMARY

Embodiments may relate to a system for detecting malware in a computer network. The system can include at least one computing node including memory storing program code for a malware detection application. The system can also include a processor trace system. The system can also include a processor for identifying malware. The processor can be configured to communicate with the memory and execute the program code for the malware detection application. The program code for the malware detection application, when executed, can cause the processor to receive a binary data stream. The program code for the malware detection application, when executed, can cause the processor to execute a processor trace on the binary data stream to dump processor trace data to the memory using the program code for the processor trace system. The program code for the malware detection application, when executed, can cause the processor to identify a network attribute associated with the binary data stream based on the processor trace data. The program code for the malware detection application, when executed, can cause the processor to extract the network attribute from the binary data stream. The program code for the malware detection application, when executed, can cause the processor to generate a script for identifying and intercepting a beacon transmission used to transmit malware data. The script can be generated based on the network attribute. The program code for the malware detection application, when executed, can cause the processor to intercept reception of the beacon transmission and malware data within the computer network.

Embodiments may relate to a computer-implemented method for detecting malware in a computer network. The method can include receiving a data stream of binary data representing a malware file at a network node. The method can also include identifying a network attribute associated with the data stream of binary data and the malware file. The method can also include extracting the network attribute to generate a script for identifying and intercepting a beacon transmission used to transmit malware data. The method can also include intercepting the beacon transmission and malware data within the computer network.

Embodiments may relate to a system for detecting malware in a computer network. The system can include memory storing program code for a binary decomposition application. The system can also include a database storing conditional attributes defining successful decompiling of binary program code. The system can also include a processor for decompiling binary program code. The processor can be configured to communicate with the memory and execute the program code for the binary decomposition application. The program code for the binary decomposition application, when executed, can cause the processor to receive a binary file including binary program code. The program code for the binary decomposition application, when executed, can cause the processor to receive text input data which defines a goal of reverse engineering the binary file. The program code for the binary decomposition application, when executed, can cause the processor to automatically decompose the text input data into one or more conditional attributes for validating a task associated with reverse engineering the binary file. The program code for the binary decomposition application, when executed, can cause the processor to iteratively generate a processor trace output by executing the binary file while tracing instructions of the processor. The program code for the binary decomposition application, when executed, can cause the processor to iteratively map the processor trace output to decompiled code output to generate a source code file based on the binary file. The program code for the binary decomposition application, when executed, can cause the processor to iteratively determine that the source code file satisfies at least one conditional attribute of the one or more conditional attributes. The program code for the binary decomposition application, when executed, can cause the processor to detect at least one malware beacon based on the source code file.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is a diagram of an exemplary system configuration for detecting malware in a computer network and/or reverse engineering binary data as disclosed herein;

FIG. 2 is a flow diagram of an exemplary method for detecting malware in a computer network and/or reverse engineering binary data as disclosed herein;

FIG. 3 is a diagram of an exemplary computing and/or network environment in which methods, systems, and/or computer program products, described herein, can be implemented as disclosed herein;

FIG. 4 is a diagram of a system workflow for a system for detecting malware in a computer network and/or reverse engineering binary data as disclosed herein;

FIG. 5 is a diagram of an exemplary strategic architect application for decomposing a goal based on text input data defining the goal as disclosed herein;

FIG. 6 is a diagram of an exemplary reverse engineering strategist application for managing analysis and completion of tasks as disclosed herein;

FIG. 7 is a diagram of an exemplary analysis pipeline including analysis applications for performing code analysis tasks on binary data as disclosed herein;

FIG. 8 is a diagram of an exemplary intelligent analysis application for generating scripts and analysis tools for further analyzing and reverse engineering binary data as disclosed herein;

FIG. 9 is a diagram of an exemplary validation system for validating reverse engineering tasks for reverse engineering the binary data; and

FIG. 10 is a diagram of exemplary components of a computing device and/or system as disclosed herein.

### DETAILED DESCRIPTION

In accordance with exemplary embodiments, specially configured computing systems (e.g., having specially configured processors) can be used for reverse engineering binary data (e.g., malicious program code samples) to collect and store data related to the binary data for subsequent detection of execution of that binary data within a computer network. Embodiments can enhance a reverse engineering process by automatically analyzing the binary data, including analysis of processor traces, decompiled code, function addresses and function boundaries, and analysis of test execution of the binary data and/or analysis of test execution of generated scripts. The generated scripts can be created to simulate or emulate functions of the binary data (e.g., a command and control server for a malware sample) such as functional communications and message transmission. According to some embodiments, specially configured computing systems programmed to automatically reverse engineer binary data and/or detect malware can reduce time, effort, and computational resources required for reverse engineering the binary data to gain valuable data and signatures associated with the binary data sample (e.g., malware sample). For example, embodiments can greatly reduce the time required to analyze and reverse engineer a malware sample such that the malware sample can be detected and live communications to/from the malware sample can be subsequently intercepted in real time. Such embodiments can also efficiently and effectively build a database of network attributes and/or signatures of various binary data samples, including malicious binary data samples, through automatic analysis and reverse engineering. Thus, embodiments do not require intensive manual analysis of binary data and/or compiled code, which is difficult to read and interpret, even for experienced professionals. Accordingly, embodiments can also efficiently and effectively automate development of analysis and/or testing tools to test binary data or generated scripts. Such automatic development of analysis and/or testing tools based on automated reverse engineering tasks has not been previously accomplished.

As such, disclosed embodiments address an important challenge in cybersecurity: a time-intensive and resource-heavy process of reverse engineering binary files and malware samples for identifying and detecting live malware. Embodiments can dynamically generate functional communication scripts based on results of analyzing binary data. Embodiments can also provide an automated milestone-based approach that breaks complex analysis tasks into manageable subtasks, including conditional attributes that can be validated by the computing system analyzing the binary data. Embodiments can provide comprehensive understanding of binary data by leveraging integration of processor trace output with decompiled code analysis. Thus, embodiments can significantly reduce analysis time, enable parallel processing of multiple binary data samples, and produce and maintain high-quality results. Disclosed embodiments address both scalability and efficiency problems in current reverse engineering practices while reducing time and resource requirements required for analysis. In this way, disclosed embodiments reducing computing resources and time required for binary data analysis can allow for more effective and efficient detection of malware within a computing network.

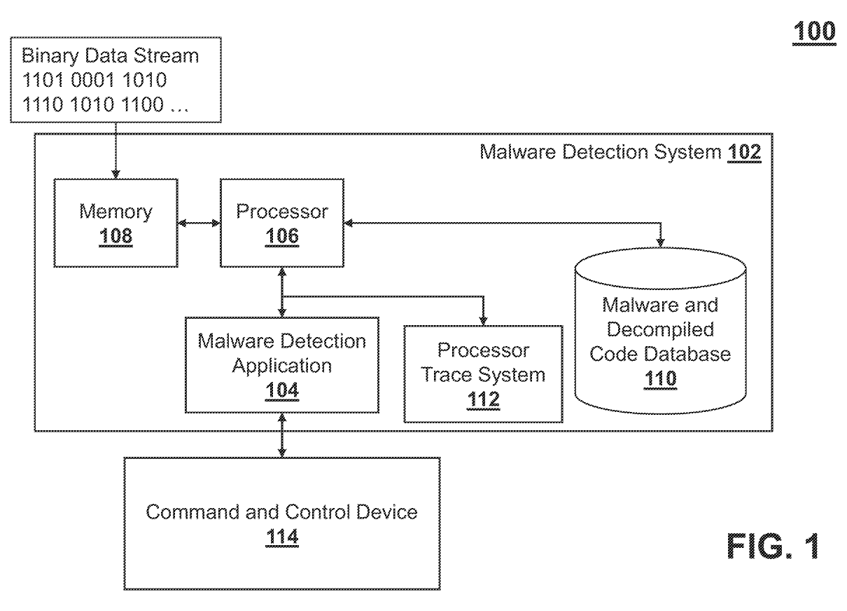

FIG. 1 shows a diagram of an exemplary system configuration for detecting malware in a computer network as disclosed herein. The various components of FIG. 1 can be implemented in and/or processed by a specially configured processor (e.g., a CPU) and/or on any number of specially configured distributed processors (e.g., a distributed and/or decentralized computing system) coupled with memory and connected via a communications network. Each of the components shown in FIG. 1 are described in the context of an exemplary embodiment.

As shown in FIG. 1, embodiments relate to a computing system 100 configured for detecting malware in a computer network. In some embodiments, computing system 100 can be specially configured for reverse engineering binary data and/or detecting malware in a computer network. Computing system 100 can include malware detection system 102, malware detection application 104, processor 106, memory 108, malware and decompiled code database 110, and processor trace system 112. Also shown in FIG. 1 is command and control device 114. Command and control device 114 can be separate from computing system 100 and/or malware detection system 102, such as in an instance where command and control device 114 represents a malicious code system and transmits/receives malware beacons to/from computing system 100 and/or malware detection system 102. In some embodiments, command and control device 114 can be included as part of computing system 100 and/or malware detection system 102, such as in an instance where a reverse engineered binary data file in a form of a script and/or decompiled program code is executed on computing system 100 and/or malware detection system 102 to identify a malware beacon (e.g., where the script file and/or decompiled program code is executed to simulate/emulate malware code that may have been included in the binary data file). Computing system 100 can be configured for reverse engineering binary data (e.g., a malware sample) and detecting malware in a computer network based on the reverse engineered and/or analyzed binary data.

Computing system 100 can be configured for detecting malware in a computer network. Computing system 100 can include at least one computing node (e.g., malware detection system 102) including memory (e.g., memory 108) storing program code for a malware detection application (e.g., malware detection application 104) and a processor trace system (e.g., processor trace system 112) and including a processor (e.g., processor 106) for identifying malware. The processor can be configured to communicate with the memory and execute the program code for the malware detection application.

The program code for the malware detection application, when executed, can cause the processor to receive a binary data stream. For example, processor 106 can execute malware detection application 104 to receive a binary data stream. The binary data stream can be received at memory 108 for access by processor 106 or the binary data stream can be received at processor 106. In some embodiments, processor 106 can receive the binary data stream as a binary file including binary data. For example, the binary data stream can include a malware sample and/or a malware file.

The program code for the malware detection application, when executed, can cause the processor to execute a processor trace on the binary data stream to dump processor trace data to the memory using the program code for the processor trace system. For example, processor 106 can execute a processor trace on the received binary data stream using processor trace system 112. Processor 106 can call processor trace system 112 using an application programming interface (API) while executing the binary data stream to execute a processor trace on the received binary data stream. Processor 106 can then dump processor trace data received from processor trace system 112 to memory 108 for analysis. Processor trace data can include one or more data packets including recorded information for execution flow of the binary data stream on processor 106, information for which instructions were executed, information for when and/or in what order instructions were executed, and information on whether conditional branches were executed. In this way, the processor trace data can allow for step-by-step execution analysis of the binary data stream.

The program code for the malware detection application, when executed, can cause the processor to identify a network attribute associated with the binary data stream based on the processor trace data. For example, processor 106 can identify a network attribute associated with the binary data stream based on the processor trace data. Processor 106 can identify a network attribute found within the binary trace data. A network attribute can include an internet protocol (IP) address, a cryptographic key used to encrypt a message within the binary data stream, a port number, a transport protocol, a cryptographic library, or a hypertext transfer protocol (HTTP) certificate. In some embodiments, a network attribute can include any information regarding transmission of information within the binary data stream. Where the binary data stream represents a malware sample and/or a malware file, the network attribute can include information about transmission of the malware, a malware beacon, and/or the like.

The program code for the malware detection application, when executed, can cause the processor to extract the network attribute from the binary data stream. For example, processor 106 can extract the network attribute from the binary data stream based on identifying the network attribute from the processor trace data. Processor 106 can extract the network attribute from the binary data stream and store the network attribute in malware and decompiled code database 110 and/or memory 108 for later use.

The program code for the malware detection application, when executed, can cause the processor to generate a script for identifying and intercepting a beacon transmission used to transmit malware data. The script can be generated based on the network attribute. For example, processor 106 can generate a script for identifying and intercepting a beacon transmission used to transmit malware data. Processor 106 can generate the script based on the network attribute, by generating a script that can exhibit a functional communication using the network attribute related to the binary data. In some embodiments, processor 106 can generate the script from reverse engineering the binary data stream, such that the script is a close representation of decompiled program code corresponding to the binary data stream. In some embodiments, processor 106 can generate the script from the processor trace data of the binary data stream, such that the script represents decompiled program code corresponding to another component or program related to the binary data stream. For example, where the binary data stream represents a malware sample and/or malware code, processor 106 can generate the script such that the script represents decompiled program code for a command and control component (e.g., a command and control server/device) that is related to the malware sample and/or the malware code. In some embodiments, the script can include functional communication aspects of the binary data stream and/or malware sample. In some embodiments, processor 106 and malware detection system 102 can use information and/or data obtained while reverse engineering the binary data stream to develop additional scripts representing tools (e.g., software tools) to further analyze and/or reverse engineer the binary data stream.

The program code for the malware detection application, when executed, can cause the processor to intercept reception of the beacon transmission and malware data within the computer network. For example, processor 106 can intercept reception of the beacon transmission and malware data within the computer network by executing the generated script or based on executing the generated script. In some embodiments, processor 106 can intercept reception of the beacon transmission and malware data within the computer network by executing the generated script where the generated script represents a command and control component of malware. Processor 106 can execute the generated script to cause transmission of a malware beacon to malware detection system 102. In this way, the reverse engineered binary data stream can provide information on malicious code by simulating a component (e.g., a command and control component) of malware code.

In some embodiments, the program code for the malware detection application, when executed, can cause the processor to execute the script to identify the beacon transmission. For example, processor 106 can execute the script to identify the beacon transmission. In some embodiments, processor 106 can execute the script to emulate the beacon transmission from command and control device 114. In some embodiments, processor 106 can execute the script to extract more information (e.g., network attributes) from the script to obtain more information for reverse engineering the binary data stream and/or to obtain more information about the binary data stream or malware file.

In some embodiments, the program code for the malware detection application, when executed, can cause the processor to store data for the beacon transmission and the network attribute in a malware database for detection of the beacon transmission within the computer network. For example, processor 106 can store data for the beacon transmission and the network attribute in malware and decompiled code database 110 for detection of the beacon transmission within the computer network. Processor 106 can store the network attribute to identify the beacon transmission, or other information, as a beacon identifier stored in malware and decompiled code database 110. A beacon identifier can include any piece of information (e.g., a network attribute) relating to the binary data stream (e.g., malware file, a command and control device, etc.) or the transmission of a malware beacon.

In some embodiments, the program code for the malware detection application, when executed, can cause the processor to generate decompiled program code based on the binary data stream. For example, processor 106 can generate decompiled program code based on the binary data stream using a code decompiling tool and/or software reverse engineering tool. The binary data stream can include compiled program code (e.g., machine code, machine-readable code, an executable file, and/or the like).

In some embodiments, the program code for the malware detection application, when executed, can cause the processor to identify a first offset and a last offset for each of plural functions in the processor trace data. For example, processor 106 can identify a first offset and a last offset for each of plural functions in the processor trace data. The processor trace data can include one or more functions identified by processor trace system 112 which were executed by processor 106 as part of executing the processor trace. The one or more functions can be represented by compiled code in the binary data stream and/or the one or more functions can be represented by program code (e.g., decompiled program code, human-readable program code, source code, and/or the like) in the processor trace data and/or the generated script.

In some embodiments, the program code for the malware detection application, when executed, can cause the processor to correlate the first offset and the last offset of each of the plural functions to the decompiled program code. For example, processor 106 can correlate the first offset and the last offset of each of the plural functions to the decompiled program code. The first offset can indicate a position in the binary data stream, relative to the processor trace data, in which a particular function began execution, or where the particular function was entered. The last offset can indicate a position in the binary data stream, relative to the processor trace data, in which a particular function terminated execution, or where the particular function was exited. In this way, entry and exit points of the plural functions can be mapped to the decompiled program code of the binary data stream to align function position and/or order of execution to the decompiled program code such that an improved structure of source code for the binary data stream can be viewed, tested, and further reverse engineered. Thus, malware detection system 102 can use the mapped processor trace and decompiled program code to more effectively reverse engineer the binary data and generate scripts that simulate/emulate the binary data stream, e.g., scripts that use similar functions and similar order of execution that was determined when mapping the processor trace data to the decompiled program code.

Computing system 100 can include memory 108 including storage locations configured to store binary data and/or binary data files, and network attributes (e.g., malware identifiers, beacon identifiers, and/or the like). Computing system 100 can include malware and decompiled code database 110 configured for storing binary data, binary data files, network attributes (e.g., malware identifiers, beacon identifiers) and/or other data related to the binary data stream and/or malware files. Computing system 100 can include processor 106 configured with malware detection application 104. Processor 106 can be specially configured to execute program code that, when executed, can cause processor 106 to execute program code for malware detection application 104. In some embodiments, processor 106 can be specially configured to execute program code that, when executed, can cause processor 106 to execute program code for processor trace system 112.

Execution of malware detection application 104 can configure processor 106 to perform various functions, as described herein. For example, malware detection application 104 can configure processor 106 to receive a binary data stream; execute a processor trace on the binary data stream to dump processor trace data to the memory using the program code for the processor trace system; identify a network attribute associated with the binary data stream based on the processor trace data; extract the network attribute from the binary data stream; generate a script for identifying and intercepting a beacon transmission used to transmit malware data; and intercept reception of the beacon transmission and malware data within the computer network.

In some embodiments, malware detection application 104 can configure processor 106 to execute other functions. Execution of malware detection application 104 can configure processor 106 to iteratively execute various functions. In some embodiments, malware detection application 104 and/or processor trace system 112 can configure processor 106 to execute any of the functions disclosed herein, and/or execute other various functions for reverse engineering binary data and/or detecting malware or other malicious code. In some embodiments, computing system 100 and/or malware detection system 102 can be implemented across plural computing systems 100 and/or plural malware detection systems 102 (e.g., plural, distributed computing nodes) within a computer network.

In some embodiments, malware detection system 102 can be implemented in a single computing device. Malware detection system 102 can be implemented in one or more computing devices (e.g., a group of servers, such as a group of computing devices, and/or the like) as a distributed and/or decentralized system such that software instructions, malware detection application 104 and/or processor trace system 112, are implemented on different computing devices. In some embodiments, malware detection system 102 can be associated with a local computing device, such that malware detection system 102 is executed on the local computing device or part of malware detection system 102 is executed on the local computing device as part of a distributed and/or decentralized computing system. Alternatively, malware detection system 102 can include at least one local computing device executing software instructions for detecting malware within a computer network.

Computing system 100 can be configured for reverse engineering binary data and/or detecting malware in a computer network. Computing system 100 can include memory (e.g., memory 108) storing program code for a binary decomposition application (e.g. the same as or similar to malware detection application 104). Computing system 100 can include a database (e.g., malware and decompiled code database 110) storing conditional attributes defining successful decompiling of binary program code. Computing system 100 can also include a processor (e.g., processor 106) for decompiling binary program code configured to communicate with the memory and execute the program code for the binary decomposition application.

The program code for the binary decomposition application, when executed, can cause the processor to receive a binary file including binary program code. For example, processor 106 can receive the binary file including binary program code for reverse engineering the binary program code to gain information and/or data about the binary file. In some embodiments, the binary file can be streamed as a stream of binary data to processor 106.

The program code for the binary decomposition application, when executed, can cause the processor to receive text input data which defines a goal of reverse engineering the binary file. For example, processor 106 can receive text input data defining a goal of reverse engineering the binary file from a user and/or a client device. The text input data can be sent to at least one large language model (LLM) for processing and or decomposition of the text input data. The text input data can define a high-level goal of reverse engineering the binary file. For example, the text input data can include text data such as “analyze a malware sample to create a command and control server.” This text input can be input to a LLM, and the LLM can tokenize and/or analyze the text input data to output a series of milestones and/or tasks that should be completed by malware detection system 102 in order to create a command and control server (e.g., command and control device 114) that corresponds to and/or is associated with the binary data file. The command and control server, generated by malware detection system 102, can be in the form of a script or program code for operating and/or simulating/emulating the command and control server.

The program code for the binary decomposition application, when executed, can cause the processor to automatically decompose the text input data into one or more conditional attributes for validating a task associated with reverse engineering the binary file. For example, processor 106 can automatically decompose the text input data into one or more conditional attributes using the LLM. The conditional attributes can be stored in malware and decompiled code database 110 and/or memory 108 for validating a task performed by processor 106 associated with reverse engineering the binary file. For example, a conditional attribute for validating a task can include whether a processor trace of the binary file was successfully performed, where the task required the processor trace of the binary file to be performed. Once processor 106 and/or processor trace system 112 performs a processor trace on the binary file and generates processor trace data, processor 106 can validate the conditional attribute and can set the conditional attribute to “TRUE” when the conditional attribute is satisfied. In this way, malware detection system 102 and processor 106 can automatically track progress of reverse engineering the binary file so that the reverse engineering process can be continually analyzed and improved.

In some embodiments, when the program code for the binary decomposition application causes the processor to automatically decompose the text input data, the program code for the binary decomposition application will cause the processor to input the text input data to at least one LLM. For example, processor 106 can automatically decompose the text input data using the text input data as input to the LLM for contextual analysis of the text. In some embodiments, an LLM can be trained based on the text input data.

In some embodiments, when the program code for the binary decomposition application causes the processor to automatically decompose the text input data, the program code for the binary decomposition application can cause the processor to generate, with the LLM, one or more milestones associated with the goal of reverse engineering the binary file defined by the text input data, where each milestone is defined by text data and at least one subtask. For example, processor 106 can generate and output (using the LLM) plural milestones in a text data format such that the plural milestones can include prompts that can be input into the LLM to further generate tasks and/or subtasks to progress in the goal for reverse engineering the binary data.

In some embodiments, when the program code for the binary decomposition application causes the processor to automatically decompose the text input data, the program code for the binary decomposition application can cause the processor to generate, with the LLM, the one or more conditional attributes based on providing the one or more milestones as input to the LLM. The one or more conditional attributes can be Boolean expressions for validating a task associated with a milestone. As an example, processor 106 can generate, with the LLM, the one or more conditional attributes based on providing the one or more milestones as input to the LLM. Processor 106 can generate text format subtasks that are associated with the conditional attributes.

The program code for the binary decomposition application, when executed, can cause the processor to iteratively generate a processor trace output by executing the binary file while tracing instructions of the processor. For example, processor 106 can begin a first iteration of reverse engineering the binary file. Processor 106 can generate a processor trace output by executing the binary file while tracing instructions of processor 106 (e.g., using processor trace system 112) during the first iteration. Processor 106 can generate subsequent processor trace outputs by executing the binary file while tracing instructions of processor 106 in subsequent iterations. In this way, processor 106 can obtain new data regarding the binary file for use in reverse engineering the binary file. It should be understood that processor 106 can perform other operations during the first iterations, and subsequent iterations, following the processor trace and before subsequent processor trace operations. Iterations are not limited only to a processor trace operation.

The program code for the binary decomposition application, when executed, can cause the processor to iteratively map the processor trace output to decompiled code output to generate a source code file based on the binary file. For example, processor 106 can map the processor trace output to decompiled code output to generate a source code file based on the binary file (e.g., source code that is logically similar or equivalent to the binary file) during a first iteration (e.g., once the processor trace output is generated). In some embodiments, the decompiled code output can be stored in a decompiled code database (e.g., malware and decompiled code database 110). Processor 106 can map the processor trace output to decompiled code output in subsequent iterations to generate subsequent source code files (or intermediate data and/or network attributes relating to the binary file) or to generate a final source code file based on the binary file during subsequent iterations. In this way, malware detection system 102 and processor 106 can iteratively analyze a binary file to obtain new insights into the binary file from data extracted from the binary file while reverse engineering the binary file. Malware detection system 102 and processor 106 can generate a final source code file once malware detection system 102 and processor 106 determine that enough data has been extracted to generate a final source code file satisfying the text input data and/or the conditional attributes such that the final source code file, when executed, can simulate/emulate the binary file and/or a portion or a component related to the binary file. For example, the source code file can represent code that is logically and/or functionally equivalent to the binary file. In some embodiments, the source code file can execute a tool that further reverse engineers and/or analyzes the binary file. In this way, the source code file can be used to intercept communications of the binary file (e.g., a malware sample).

In some embodiments, when the program code for the binary decomposition application causes the processor to map the processor trace output to the decompiled code output to generate the source code file, the program code for the binary decomposition application can cause the processor to identify a first offset and a last offset for each of plural functions in the processor trace output. For example, processor 106 can identify a first offset and a last offset for each of plural functions present in the processor trace output.

In some embodiments, when the program code for the binary decomposition application causes the processor to map the processor trace output to the decompiled code output to generate the source code file, the program code for the binary decomposition application can cause the processor to correlate each function to the decompiled code output using the first offset and the last offset for each function. For example, processor 106 can correlate each function to the decompiled code output using the first offset and the last offset for each function.

The program code for the binary decomposition application, when executed, can cause the processor to iteratively determine that the source code file satisfies at least one conditional attribute of the one or more conditional attributes. For example, processor 106 can iteratively determine that the source code file satisfies at least one conditional attribute of the one or more conditional attributes. Processor 106 can terminate the iterations once processor 106 determines that the source code file satisfies at least one conditional attribute. Processor 106 can begin a new set of iterations for analyzing the binary file if further conditional attributes exist that should be satisfied. Processor 106 can terminate the iterations once processor 106 determines that the source code file satisfies all conditional attributes. If processor 106 determines that the at least one conditional attribute is not satisfied, processor 106 can begin a new iteration.

In some embodiments, when the program code for the binary decomposition application causes the processor to determine that the source code file satisfies the at least one conditional attribute, the program code for the binary decomposition application can cause the processor to execute the source code file for test execution to validate the at least one conditional attribute. Executing the source code file can cause at least one output that satisfies the at least one conditional attribute. For example, processor 106 can execute the source code file for test execution to validate the at least one conditional attribute. Processor 106 can determine that at least one output or at least one attribute (e.g., a network attribute) of the source code file satisfies the at least one conditional attribute.

In some embodiments, when the program code for the binary decomposition application causes the processor to determine that the source code file satisfies the at least one conditional attribute, the program code for the binary decomposition application can cause the processor to store the source code file in a malware database for malware analysis based on satisfying the at least one conditional attribute. For example, processor 106 can store the source code file in malware and decompiled code database 110 for malware analysis based on satisfying the at least one conditional attribute. In this way, malware detection system 102 can store the source code file for later execution for analyzing and/or simulating/emulating malware code or for detecting and intercepting transmission of malware beacons. The source code file can represent a malware file directly or the source code file can represent a component associated with a malware file (e.g., a command and control server) such that execution of the source code file provides simulation/emulation of aspects of the malware code so the malware code can be studied and detected if the malware code is used maliciously. In this way, the generated source code file can operate logically and/or functionally the same as a component of malware such that the source code file can be executed in conjunction with the binary file to communicate with and/or intercept communications of the binary file.

In some embodiments, the source code file can include a script that, when executed by the processor, causes the processor to simulate or emulate a communication message transmitted by program code for malware. For example, processor 106 can execute the source code file (e.g., a script) such that processor 106 can execute commands associated with a command and control server. In some embodiments, a processor executing the source code file can act as a command and control server that is related to the binary data (e.g., the malicious program code) such that malware detection system 102 can analyze data and network traffic of the command and control server to intercept and/or collect malware data and/or network attributes related to the binary data. The malware data and/or network attributes can be stored in malware and decompiled code database 110 for subsequent detection of live malware attacks and live messages from malware code to command and control servers within a computing network. In this way, malware detection system 102 can efficiently collect malware data and/or network attributes by automating reverse engineering tasks to reverse engineer the binary data and analyze a malware sample before similar malware can infect the computing network.

The program code for the binary decomposition application, when executed, can cause the processor to detect at least one malware beacon based on the source code file. For example, processor 106 can detect at least one malware beacon transmitted to/from a command and control server (e.g., whether simulated/emulated by a source code file available in malware and decompiled code database 110 or transmitted by an operating malicious command and control server) based on the analysis of the binary file. Processor 106 can use malware data, such as network attributes associated with a malware file (e.g., the binary file) stored in malware and decompiled code database 110, to analyze and identify a beacon transmission, or identify network attributes of a malware beacon transmission. In some embodiments, processor 106 can identify network attributes by executing the source code file (e.g., a decompiled version of the binary file, stored in malware and decompiled code database 110) to determine the network attributes from execution of a decompiled version of the malware file. Additionally or alternatively, processor 106 can identify the network attributes by analyzing the decompiled code of the source code file (e.g., stored in malware and decompiled code database 110) to determine the network attributes stored and/or present in the decompiled code of the source code file. Based on the identified network attributes, processor 106 can detect the malware beacon when the malware beacon is transmitted by intercepting a data transmission and determining that the data transmission includes at least one of the identified network attributes.

Malware detection system 102 (e.g., processor 106 thereof) can iteratively execute functions including generating a processor trace output by executing the binary file while tracing instructions of the processor, map the processor trace output to decompiled code output to generate a source code file based on the binary file, and determine that the source code file satisfies at least one conditional attribute of the one or more conditional attributes. Additionally, malware detection system 102 (e.g., processor 106 thereof) can execute functions including terminating execution of the iterative functions.

Computing system 100 can include one or more computing devices (e.g., malware detection system 102) including one or more processors (e.g., processor 106) configured to execute software instructions. For example, malware detection system 102 can include a desktop computer, a portable computer (e.g., laptop computer, tablet computer), a workstation, a mobile device (e.g., smartphone, cellular phone, personal digital assistant, wearable device), a server, and/or other like devices. Malware detection system 102 can include a computing device configured to communicate with one or more other computing devices over a network. Malware detection system 102 can include a group of computing devices (e.g., a group of servers) and/or other like devices. In some embodiments, malware detection system 102 can include a data storage device (e.g., malware and decompiled code database 110) for storing conditional attributes, malware code and/or malware data, and decompiled code. Alternatively, a data storage device can be separate from malware detection system 102 and can be in communication with malware detection system 102 over a network.

Processor 106 can be implemented in hardware, software, or a combination of hardware and software. For example, processor 106 can include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or can execute software instructions to perform a function. Processor 106 can be coupled to memory 108 via a data bus to transfer data between processor 106 and memory 108.

Memory 108 can include random access memory (RAM), read-only memory (ROM), and/or another type of dynamic or static storage device (e.g., flash memory, magnetic memory, optical memory, etc.) that stores information and/or software instructions for use by processor 106. Memory 108 can include a computer-readable medium and/or a storage component. A computer-readable medium (e.g., a non-transitory computer-readable medium) is defined herein as a non-transitory memory device. A non-transitory memory device includes memory space located inside of a single physical storage device or memory space spread across multiple physical storage devices. In some embodiments, memory 108 can include one or more storage locations for storing data, binary data, malware data, and/or data associated with conditional attributes.

Software instructions can be read into memory 108 from another computer-readable medium or from another device via a communication interface with malware detection system 102. When executed, software instructions stored in memory 108 can cause processor 106 to perform one or more processes and/or functions described herein. Embodiments described herein are not limited to any specific combination of hardware circuitry and software and can include various combinations of hardware circuitry and software.

Malware and decompiled code database 110 can include random access memory (RAM), read only memory (ROM), and/or another type of dynamic or static storage device (e.g., flash memory, magnetic memory, optical memory, etc.) that stores information for use by malware detection system 102 and/or processor 106. For example, malware and decompiled code database 110 can store one or more malware samples and/or data associated with one or more malware samples (e.g., network attributes, conditional attributes, decompiled code, source code files, scripts, etc.). Malware and decompiled code database 110 can store machine learning models and/or LLMs for use by malware detection system 102 and/or processor 106. In some embodiments, malware and decompiled code database 110 can store decompiled code, or binary data decompiled into source code and/or pseudo source code. In some embodiments, malware and decompiled code database 110 can include a non-transitory computer readable medium that can store information, software, and/or machine learning models related to the operation and use of malware detection system 102 and/or processor 106. For example, malware and decompiled code database 110 can include a hard disk (e.g., a magnetic disk, an optical disk, a magneto-optic disk, a solid-state disk, etc.) and/or another type of computer-readable medium. In some embodiments, malware detection system 102 and/or processor 106 can transmit information to and/or receive information from malware and decompiled code database 110.

Malware and decompiled code database 110 can include a computing device (e.g., a database device) configured to communicate with processor 106 (e.g., via malware detection application 104) via a bus or a network environment. For example, malware and decompiled code database 110 can include a server, a group of servers, and/or other like devices. In some embodiments, malware and decompiled code database 110 can be associated with one or more computing devices providing interfaces such that a user can interact with malware and decompiled code database 110 via the one or more computing devices. Malware and decompiled code database 110 can be in communication with malware detection system 102 and/or processor 106 such that malware and decompiled code database 110 is separate from malware detection system 102 and/or processor 106. Alternatively, malware and decompiled code database 110 can be part of (e.g., a component of) malware detection system 102 (e.g., as shown in FIG. 1).

In some embodiments, malware and decompiled code database 110 can include a device capable of storing data (e.g., a database). In some embodiments, malware and decompiled code database 110 can include a collection of data (e.g., malware data elements, decompiled code, network attributes, etc.) stored and accessed by one or more computing devices. Malware and decompiled code database 110 can include file system storage, cloud storage, in-memory storage, and/or the like. Malware and decompiled code database 110 can include non-volatile storage (e.g., flash memory, magnetic media), volatile storage (e.g., random access memory (RAM)), or both non-volatile and volatile storage. In some embodiments, malware and decompiled code database 110 can be hosted (e.g., stored and permitted to be accessed by other computing devices via a network environment) on a computing device separate from malware detection system 102. Malware and decompiled code database 110 can be configured to communicate with processor 106 via malware detection application 104.

As used herein, an application (e.g., software application, software/hardware module, and/or the like) or a service (e.g., software service, microservice, and/or the like) can refer to a loosely-coupled software application and/or a loosely-coupled software service that is designed to facilitate software reuse and high cohesion. In a microservice architecture, software services can be fine-grained and protocols can generally be lightweight, requiring minimal software dependencies. Software applications and/or services can include interfaces which are treated as a public API. The software application and/or software service can exist and may be reusable (e.g., portable to other software applications and/or systems without requiring changes to the software application) independent of other software applications and/or software services.

Malware detection application 104 can include a component (e.g., programmed hardware component, software component) for interfacing processor 106 with at least memory 108, malware and decompiled code database 110, and/or processor trace system 112. For example, malware detection application 104 can allow processor 106 to interface with memory 108 such that processor 106 can store and/or retrieve objects and/or data in memory 108 (e.g., binary data, binary files, network attributes, conditional attributes, and/or the like). Malware detection application 104 can include program code that causes processor 106 to execute API calls to processor trace system 112 to perform a processor trace on another file (e.g., a source code file, a script) being executed. In some embodiments, malware detection application 104 can include a software application (e.g., an application invoked by processor 106 based on program code executed by processor 106) such that functionalities of malware detection application 104 can be accessed via an API. In some embodiments, malware detection application 104 can include a software application such that malware detection application 104 can be packaged into a single unit (e.g., a single unit of reusable program code) that can be easily deployed and/or shared between computing devices and/or multiple computing systems 100. In some embodiments, malware detection application 104 can include a combination of hardware and software (e.g., a specially configured processor, an embedded system, a separate computing node) such that malware detection application 104 can perform functions and share data and/or commands with processor 106, where malware detection application 104 is executed on hardware separate from processor 106. Alternatively, malware detection application 104 can include a software application and/or service including various program instructions that can be executed by processor 106. The program instructions for malware detection application 104 can cause processor 106 to interface with memory 108 to manipulate objects and/or data (e.g., binary data, binary files, network attributes, conditional attributes, and/or the like). For example, malware detection application 104 can include various functions in program code that can cause processor 106 to performs functions described herein.

As disclosed herein, an application can include software, hardware, or a combination of software and hardware. As an example, where malware detection application 104 can include program code that, when executed by processor 106, will cause processor 106 to perform various actions, malware detection application 104 can include program code including various functions that cause processor 106 to be configured to perform the various functions when processor 106 executes malware detection application 104. Alternatively, where malware detection application 104 includes program code and/or computer instructions (e.g., via hardware or software) in a combination of software and hardware, malware detection application 104 can include a package of program code and hardware (e.g., a specially configured processor, an embedded system, a separate computing node) to perform various functions independent of and/or in conjunction with processor 106. In this way, malware detection application 104 can include various functions (e.g., via hardware or software) where malware detection application 104 can be configured with its own hardware and/or processor for performing the various functions and malware detection application 104 can be integrated with processor 106 to form a packaged malware detection system 102 including a specially programmed and/or configured processor.

Processor trace system 112 can include a component (e.g., programmed hardware component, software component) for interfacing processor 106 and/or malware detection application 104 with a processor trace application. For example, processor trace system 112 can allow processor 106 to interface with a processor trace application such that processor 106 can execute a processor trace of another application, file, script, and/or program code. In some embodiments, processor trace system 112 can include a software application (e.g., an application invoked by processor 106 based on program code executed by processor 106) such that functionalities of processor trace system 112 can be accessed via an API. In some embodiments, processor trace system 112 can include a software application such that processor trace system 112 can be packaged into a single unit (e.g., a single unit of reusable program code) that may be easily deployed and/or shared between computing devices and/or multiple computing systems 100. In some embodiments, processor trace system 112 can include a combination of hardware and software (e.g., a specially configured processor to perform certain functions) such that processor trace system 112 is separate from processor 106 and can perform functions and share data and/or commands with processor 106. Processor trace system 112 can include various functions (e.g., via hardware or software) that can allow processor 106 to call processor trace system 112 to execute a processor trace on a software application, a binary file, a script file, and/or other compiled and/or executable program code to generate processor trace data. For example, processor trace system 112 can include various functions in program code that can cause processor 106 to performs functions described herein and/or that can allow processor 106 to invoke processor trace system 112 (e.g., via an API) to execute a processor trace.

As disclosed herein, an application can include software, hardware, or a combination of software and hardware. As an example, where processor trace system 112 includes program code that, when executed by processor 106, can cause processor 106 to perform various actions, processor trace system 112 can include program code including various functions that cause processor 106 to be configured to perform the various functions when processor 106 executes processor trace system 112 and/or executes API calls to processor trace system 112. Alternatively, where processor trace system 112 includes various functions (e.g., via hardware or software) in a combination of software and hardware, processor trace system 112 can include a package of program code and hardware (e.g., a specially configured processor, an embedded system, a separate computing node) to perform the various functions independent of and/or in conjunction with processor 106, where processor trace system 112 includes hardware and/or software separate from processor 106. In this way, processor trace system 112 can include program code where processor trace system 112 can be configured with its own hardware and/or processor for performing various functions and processor trace system 112 can be integrated with malware detection system 102 to form a packaged processor trace system 112 including a specially programmed and/or configured processor.

As shown in FIG. 1, malware detection system 102 (e.g., processor 106 thereof) can perform various functions based on processor 106 being configured to execute program code that, when executed, can cause processor 106 to execute malware detection application 104 (e.g., program code for malware detection application 104) and processor trace system 112 (e.g., program code for processor trace system 112). In some embodiments, processor 106 can execute malware detection application 104 and/or processor trace system 112 as program code. Alternatively, processor 106 can execute malware detection application 104 and/or processor trace system 112 by communicating with a first specially configured processor and/or computing device corresponding to malware detection application 104 and/or communicating with a second specially configured processor and/or computing device corresponding to processor trace system 112, for example, via an API or via a remote procedure call (RPC), where malware detection application 104 and/or processor trace system 112 can be configured with first program code and second program code, respectively.

The number and arrangement of systems, hardware, and/or applications shown in FIG. 1 is provided as an example. There may be additional systems, hardware, and/or applications, fewer systems, hardware, and/or applications, different systems, hardware, and/or applications, or differently arranged systems, hardware, and/or applications than those shown in FIG. 1. Furthermore, two or more systems, hardware, and/or applications shown in FIG. 1 can be implemented within a single system, hardware, and/or application. A single system, hardware, and/or application shown in FIG. 1 can be implemented as multiple, distributed systems, hardware, and/or applications. Additionally, or alternatively, a set of systems, a set of hardware, and/or a set of applications (e.g., one or more systems, one or more hardware devices, one or more modules) of FIG. 1 can perform one or more functions described as being performed by another set of systems, another set of hardware, or another set of applications of FIG. 1.

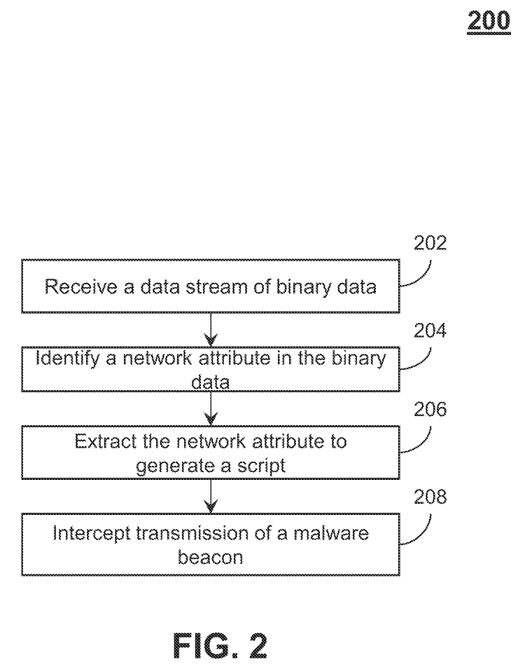

FIG. 2 shows a flow diagram of an exemplary method 200 for detecting malware in a computer network and/or reverse engineering binary data as disclosed herein. In some embodiments, one or more of the functions described with respect to method 200 can be performed (e.g., completely, partially, etc.) by malware detection system 102 (e.g., via processor 106). In some embodiments, one or more of the steps of method 200 can be performed (e.g., completely, partially, etc.) by another system, hardware, or application or a group of systems, hardware, or applications separate from or including malware detection system 102, such as a client device and/or a separate computing device.

As shown in FIG. 2, at step 202, method 200 can include receiving a data stream of binary data. For example, malware detection system 102 (e.g., processor 106 thereof) can receive a data stream of binary data representing a malware file at a network node. The binary data stream can be compiled code for a malware file or a file representing malicious code. Processor 106 can receive the binary data stream as streaming data or processor 106 can receive the binary data stream in a file including binary data. Processor 106 can receive the binary data stream as a static sample of executable malicious code.

At step 204, method 200 can include identifying a network attribute in the binary data. For example, malware detection system 102 can identify a network attribute associated with the data stream of binary data and the malware file. A network attribute can include network information associated with and/or used in execution of the malware file. For example, the network attribute can include an IP address, a cryptographic key used to encrypt a message transmitted by the malware file when executed, a port number, a transport protocol, a cryptographic library, or a HTTP certificate. It should be understood that other network attributes can be identified in the binary data, and each of the identified network attributes can be stored by processor 106 in malware and decompiled code database 110 for analysis of binary data files and/or detection of malware.

In some embodiments, identifying a network attribute can include generating at least one conditional attribute representing validation criteria for a task to be satisfied. The at least one conditional attribute can be validated by executing the script which includes the network attribute. For example, processor 106, when identifying the network attribute, can generate at least one conditional attribute representing validation criteria for a task to be satisfied.

In some embodiments, extracting the network attribute can include executing the script for test execution to validate the at least one conditional attribute. The script can satisfy the at least one conditional attribute upon execution. For example, a property and/or a function of the script can satisfy the at least one conditional attribute, or an output of the script can satisfy the at least one conditional attribute. In some embodiments, extracting the network attribute can include storing the script in a detection database (e.g., malware and decompiled code database 110) for malware detection based on satisfying the at least one conditional attribute.

In some embodiments, identifying the network attribute and extracting the network attribute can include executing the binary data representing the malware file to trace processor instructions. For example, processor 106 can execute the binary data representing the malware file to trace processor instructions while making API calls to processor trace system 112 to trace the processor instructions.

In some embodiments, identifying the network attribute and extracting the network attribute can include generating a processor trace output based on executing the binary data. For example, processor 106 can generate a processor trace output based on executing the binary data and executing a processor trace by calling processor trace system 112.

In some embodiments, identifying the network attribute and extracting the network attribute can include generating decompiled program code based on the binary data using a decompiling application. For example, malware detection application 104 can cause processor 106 to generate decompiled program code based on the binary data using a reverse engineering code decompilation tool, such as Ghidra. Processor 106 can store the decompiled program code output in malware and decompiled code database 110 for further analysis.

In some embodiments, identifying the network attribute and extracting the network attribute can include integrating the processor trace output with the decompiled program code to generate the script for identifying and intercepting the beacon. For example, malware detection application 104 can cause processor 106 to integrate the processor trace output with the decompiled program code to generate a script that can be used for identifying and intercepting the beacon transmission. By integrating the processor trace output with the decompiled program code, a more comprehensive view of the binary data and/or binary file in a decompiled source code version can be formed. Binary data and/or a binary file in a decompiled source code form allows for more effective analysis by malware detection system 102, because malware detection system 102 can compare conditional attributes to portions of the decompiled source code form because the decompiled source code form can be similar to a human-readable version of the binary data. Tools such as LLMs can be leveraged to further analyze the decompiled source code form to improve analysis and reverse engineering of the binary data to create tools and scripts for identifying properties of the original binary data (such as malware beacons, or other attributes of malicious code). Thus, when processor 106 integrates the processor trace output with the decompiled program code, processor 106 can analyze the integrated decompiled program code and processor trace output to generate a script that can simulate/emulate the original binary file. Processor 106 can then test the script in a testing environment (e.g., in a virtual machine, a sandbox environment, and/or the like) to analyze malicious binary data (where the binary data represented a malware file, or other malicious file). Through testing the script, processor 106 can identify more data and/or network attributes associated with the binary data that can be used for identifying and intercepting a transmission from malicious program code similar to originally analyzed binary data (e.g., such as a beacon transmission to a command and control server for malware).

At step 206, method 200 can include extracting the network attribute to generate a script. For example, malware detection system 102 (e.g., processor 106 thereof) can extract the network attribute to generate a script for identifying and intercepting a beacon transmission used to transmit malware data. Processor 106 can extract the network attribute and can store the network attribute in malware and decompiled code database 110 for later use and/or later identification of malware or transmission of a malware beacon. In some embodiments, the network attribute may be useful for identifying transmission of a malware beacon because the network attribute may match an attribute of the transmission of the malware beacon (e.g., a source/destination IP address, a cryptographic key used to encrypt the transmission of the malware beacon, a port number used to transmit the malware beacon, a transport protocol used for transmission of the malware beacon, or other attribute). Additionally, the network attribute can provide information or insight into an aspect of the malware file, such that communications by the malware file or execution of the malware file can be identified. Reverse engineering the binary data may be required to determine the network attribute, and the network attribute could be a key component in identifying and/or emulating malicious code such that the malicious code can be identified when it is executed for a malicious purpose.

At step 208, method 200 can include intercepting transmission of a malware beacon. For example, malware detection system 102 (e.g., processor 106 thereof) can intercept the beacon transmission and malware data within the computer network. Processor 106 can intercept the beacon transmission and malware data because processor 106 can access the network attribute stored in malware and decompiled code database 110 and processor 106 can compare the network attribute to an attribute of the beacon transmission and/or the malware data. Processor 106 can positively identify and intercept the beacon transmission where at least one network attribute stored in malware and decompiled code database 110 matches a network attribute of the beacon transmission. Additionally, processor 106 can execute a script and/or program code generated based on reverse engineering the binary data stream, where executing the script provides emulation of malware and/or provides insight into the malware data such that the malware data within the beacon transmission can be identified by processor 106.

Steps of method 200 can be performed in various orders and sequences and are not necessarily limited to being performed in the order shown in FIG. 2. Accordingly, steps of method 200 are not limited to any particular order and can be performed by various components or applications, whether malware detection system 102 is implemented on a single computing device or multiple, distributed computing devices. Steps of method 200 can also be performed by a single processor of malware detection system 102 or by multiple processors of malware detection system 102.

It should be understood that techniques disclosed herein are not limited to any particular type of malware and techniques disclosed herein can be used to reverse engineer and/or counter binary data and/or binary files representing various types of malicious program code (e.g., ransomware, computer viruses, trojan horse, spyware, and/or the like).

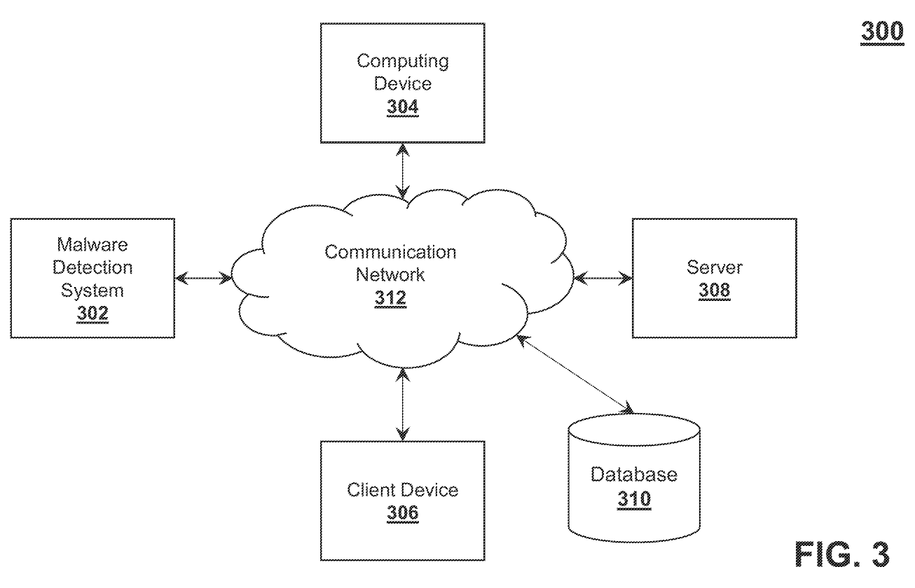

FIG. 3 shows a diagram of an exemplary computing and/or network environment 300 in which methods, systems, and/or computer program products, described herein, can be implemented as disclosed herein. Computing and/or network environment 300 can include malware detection system 302, computing device 304, client device 306, server 308, database 310, and communication network 312. In some embodiments, each of computing device 304, client device 306, server 308, database 310, and/or communication network 312 can be implemented by (e.g., as part of) malware detection system 302. In some embodiments, at least one of each of computing device 304, client device 306, server 308, database 310, and/or communication network 312 can be implemented by (e.g., as part of) another system, another device, another group of systems, or another group of devices, separate from or including malware detection system 302, such as computing device 304, client device 306, server 308, database 310, and/or the like.

Malware detection system 302 can include one or more devices capable of receiving information from and/or communicating information to computing device 304, client devices 306, server 308, and/or database 310 via communication network 312. For example, malware detection system 302 can include a computing device, such as a server, a group of servers, and/or other like devices. In some embodiments, malware detection system 302 can be associated with a server as described herein. In some embodiments, malware detection system 302 can be in communication with a data storage device (e.g., database 310, and/or the like), which can be local or remote to malware detection system 302. In some embodiments, malware detection system 302 can be configured to receive information from, storing information in, communicating information to, or searching information stored in the data storage device. In some embodiments, malware detection system 302 can be the same as or similar to computing device 100 and/or malware detection system 102, and other systems or devices that can perform the steps of method 200.

Computing device 304 can include one or more devices capable of receiving information and/or communicating information to malware detection system 302, client device 306, server 308, and/or database 310 via communication network 312. For example, computing device 304 can include a computing device, such as a server, a group of servers, and/or other like devices. In some embodiments, computing device 304 can be associated with a server, a client device, and/or a user device as described herein.

Client device 306 can include one or more devices capable of receiving information from and/or communicating information to malware detection system 302, computing device 304, server 308, and/or database 310 via communication network 312. Additionally or alternatively, one or more client devices 306 can include a device capable of receiving information from and/or communicating information to other client devices 306 via communication network 312, another network (e.g., an ad hoc network, a local network, a private network, a virtual private network, and/or the like), and/or any other suitable communication technique. For example, client device 306 can include a user device and/or the like. In some embodiments, client device 306 can include at least one virtual machine for executing scripts and/or source code files that can contain and/or simulate/emulate malicious program code.

Server 308 (and “server” as used herein) can include one or more computing devices (e.g., one or more computing devices 306) that are operated by or facilitate communication and processing for multiple parties (e.g., clients, client devices, users, and/or the like) in a network environment (e.g., network environment 300), such as the Internet, although it will be appreciated that communication may be facilitated over one or more public or private network environments (e.g., communication network 312) and that various other arrangements are possible. Further, multiple computing devices (e.g., servers 308, computing devices 306, etc.) directly or indirectly communicating in the network environment can constitute a “system.” In some embodiments, server 308 can execute and/or operate, processor trace system 112, malware detection application 104 and/or malware detection system 302.

Database 310 can include a computing device (e.g., a database device) configured to communicate with malware detection system 302, computing device 304, client device 306, and/or server 308 via communication network 312. For example, database 310 can include a server, a group of servers, and/or other like devices. In some embodiments, database 310 can be associated with one or more computing devices providing interfaces such that a user can interact with database 310 via the one or more computing devices. Database 310 may be in communication with malware detection system 302 such that database 310 is separate from malware detection system 302. Alternatively, in some embodiments, database 310 can be part of (e.g., a component of) malware detection system 302.

In some embodiments, database 310 can include a device capable of storing data (e.g., a storage device). In some embodiments, database 310 can include a collection of data stored and accessed by one or more computing devices. Database 310 can include file system storage, cloud storage, in-memory storage, and/or the like. Database 310 can include non-volatile storage (e.g., flash memory, magnetic media, and/or the like), volatile storage (e.g., random-access memory and/or the like), or both non-volatile and volatile storage. In some embodiments, database 310 can be part of (e.g., a component of) malware detection system 302.

Communication network 312 can include one or more wired and/or wireless networks. For example, communication network 312 can include a cellular network (e.g., a long-term evolution (LTE^{®}) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with malware detection system 302), an ad hoc network, an intranet, the Internet, a fiber optic-based network, a cloud computing network, and/or the like, and/or a combination of these or other types of networks.

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 can be implemented within a single system or device, or a single system or device shown in FIG. 3 can be implemented as multiple, distributed systems or devices. Additionally or alternatively, a set of systems (e.g., one or more systems) or a set of devices (e.g., one or more devices) of environment 300 can perform one or more functions described as being performed by another set of systems or another set of devices of environment 300.

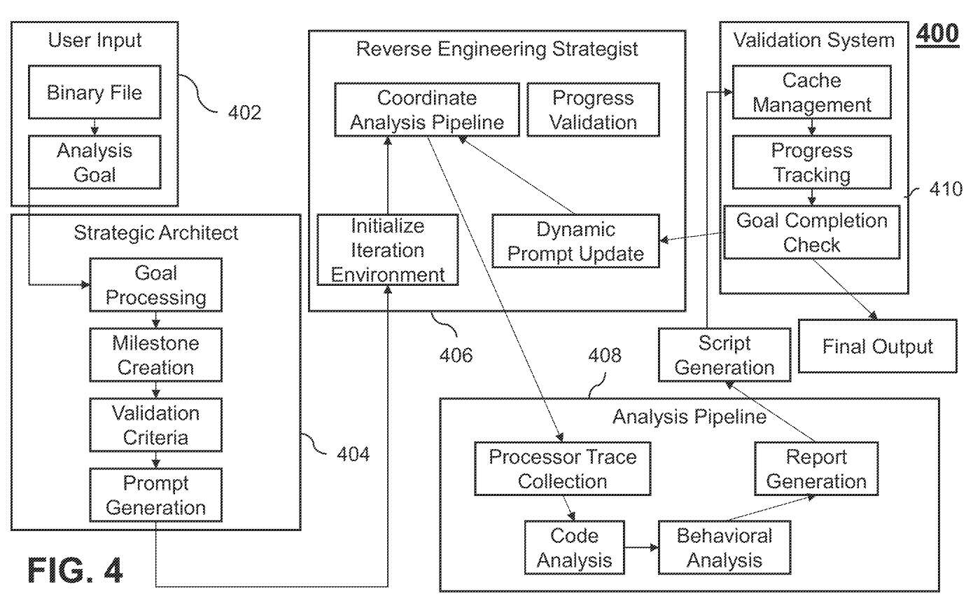

FIG. 4 shows a diagram of a system workflow 400 for a system for detecting malware in a computer network and/or reverse engineering binary data as disclosed herein. As shown in FIG. 4, user input 402 can begin system workflow 400. User input 402 can include text input data defining an analysis goal for binary data. User input 402 can also include binary data and/or a binary data file. User input 402 can be provided via an input device to a computing device including a processor. For example, user input 402 can be transmitted to malware detection system 102 and/or processor 106 via an input device. Malware detection system 102 and/or processor 106 can receive user input 402 for processing (e.g., with an LLM).

FIG. 4 shows strategic architect 404, which can include an application (e.g., software application, program code) to perform the functions shown therein. For example, strategic architect 404 can include a software module that processes and/or performs functions with user input 402. Strategic architect 404 can include functions of goal processing, milestone creation, validation criteria, and/or prompt generation. For example, strategic architect 404 can receive user input 402 including binary data and text input defining an analysis goal for the binary data (e.g., for reverse engineering the binary data). Strategic architect 404 can perform goal processing by analyzing the text input defining the analysis goal. In some embodiments, the text input can be processed as a “string” data type. For example, strategic architect 404 can input the text input to an LLM to process the text input and decompose the text input into different contextual categories to define structured milestones for reverse engineering the binary data.

As an example, text input for strategic architect 404 can include a string such as “analyze the binary data sample and create a command and control server.” Strategic architect 404 can analyze the text input by providing the text input to an LLM for analysis. The LLM can break down the text input based on the context of the goal the text input defines (e.g., “create a command and control server”). The LLM can then generate plural milestones (e.g., in a text output and/or string data format) where each milestone can define various tasks and/or subtasks that should be completed and/or validated in order to satisfy the goal defined by the text input. Generation of the plural milestones can be performed by strategic architect 404 at the milestone creation step shown in FIG. 4.

Strategic architect 404 can also generate conditional attributes at a validation criteria step. In this way, conditional attributes pertaining to the binary data and/or reverse engineering of the binary data serve as validation criteria to validate the goal, milestones, and/or subtasks defined by the text input and the LLM. For example, strategic architect 404 can generate one or more conditional attributes for reverse engineering the binary data based on the milestones and/or subtasks generated at milestone creation. The conditional attributes can include a conditional check (e.g., a Boolean variable and/or conditional Boolean statement) that should be satisfied by the binary data and/or any scripts or source code generated based on the binary data. Following the above example, where the text input includes a string such as “analyze the binary data sample and create a command and control server”, a conditional attribute that is generated based on the text input can include a condition of the generated script and/or source code (e.g., a script and/or source code that when executed simulates/emulates a command and control server, as required by the goal defined by the text input). The condition may require that the generated script and/or source code can execute a specific command related to the command and control server. Thus, the conditional attribute can be satisfied where the generated script and/or source code can successfully execute the specific command. Alternatively, the conditional attribute is not satisfied where the generated script and/or source code cannot execute the specific command. Where the conditional attribute is not satisfied, malware detection system 102 can determine that further analysis and/or reverse engineering is required until the conditional attribute can be satisfied. Such conditional attributes can be stored in malware and decompiled code database 110. In this way, strategy architect 404 can generate conditional attributes based on the text input defining the goal for analysis of the binary data as well as the milestones and/or subtasks that are generated (e.g., by the LLM) based on the defined goal in the text input.

Strategic architect 404 can also include generating prompts at the prompt generation step shown in FIG. 4. A prompt can include a command that can be transmitted to a computing device and/or an application (e.g., malware detection system 102, malware detection application 104). The command can include instructions (e.g., program instructions) for performing actions related to analyzing and/or reverse engineering the binary data. For example, strategic architect 404 can generate a prompt which causes malware detection system 102 to perform a processor trace on the binary data. The prompt can instruct malware detection system 102 to transmit API calls to processor trace system 112 in order to execute the processor trace on the binary data. In some embodiments, prompts can include other commands and/or instructions for analyzing and/or reverse engineering the binary data. Once strategic architect 404 generates the prompts, strategic architect can transmit the prompts to a computing device (e.g., malware detection system 102) executing reverse engineering strategist 406 (e.g., an application, program instructions, a separate computing device, and/or the like) to begin initializing an environment for analysis and/or reverse engineering the binary data.

Reverse engineering strategist 406 can include initializing an iteration environment. For example, reverse engineering strategist 406 can initialize the iteration environment by defining and initializing an iteration count variable. Reverse engineering strategist 406 can initialize the iteration count variable to “0” to begin iterations with analysis of the binary data, for example, by beginning execution of a processor trace with processor trace system 112 to begin an iteration of analyzing and/or reverse engineering the binary data. Reverse engineering strategist 406 can receive decomposed milestones and/or subtasks along with the prompts from strategic architect 404.

Reverse engineering strategist 406 can also include coordinating an analysis pipeline for the binary data. For example, reverse engineering strategist 406 can coordinate the analysis pipeline by managing and/or monitoring execution of a processor trace (e.g., by transmitting API calls to processor trace system 112 and receiving and managing responses from processor trace system 112), by managing and/or monitoring code analysis of the processor trace output and/or decompiler output, and by managing and/or monitoring a behavioral analysis, such as testing conditional attributes and/or monitoring whether conditional attributes are or are not satisfied, and by facilitating generation of reports based on the processor trace output, decompiler output, the code analysis results, and/or the behavioral analysis results. As shown in FIG. 4, reverse engineering strategist 406 can manage and/or monitor analysis pipeline 408 by managing and/or monitoring processor trace collection, code analysis, behavioral analysis, and report generation.

Analysis pipeline 408 can include a processor trace collection step, a code analysis step, a behavioral analysis step, and a report generation step. The processor trace collection step can include executing a processor trace on the binary data (e.g., using processor trace system 112) to generate processor trace output. The code analysis step can include performing decompiling of the binary data using a decompiler tool and the code analysis step can include analyzing decompiled code and analyzing the processor trace output. The code analysis step can also include correlating the decompiled code with the processor trace output. The behavioral analysis step can include analyzing the processor trace output and automatically reconstructing execution paths corresponding to execution of the binary data. In this way, the behavioral analysis step can analyze behavior of binary data when the binary data is executed (e.g., analyzing execution behavior of a malware sample).

The report generation can include generating a report for analysis of the binary data. The report can include data indications that indicate whether any conditional attributes have been satisfied by analysis pipeline 408, or whether any conditional attributes have not been satisfied based on analysis and/or reverse engineering of the binary data. Following report generation, malware detection system 102 can generate a script (or source code) based on the report. Once malware detection system 102 has generated a script, the script can be transmitted from analysis pipeline 408 to reverse engineering strategist 406 for transmission to validation system 410 for validating the script against the conditional attributes, subtasks, milestones, and the goal defined by the text input.

Validation system 410 can validate the conditional attributes. For example, validation system 410 can check whether the script exists and has been generated. Conditional attributes can include plural conditional properties, including a description, a type, a requirement, and a variable indicating whether the conditional attribute has been satisfied or not satisfied (e.g., passed/failed). In some embodiments, validation system 410 can check whether the script requires a coverage increase or whether coverage of the script in relation to the binary data is sufficient. For example, validation system 410 can determine that where a generated script has code coverage of at least 75% of the binary data, the script is sufficient to be validated and pass the conditional attribute.

Validation system 410 can perform cache management using the generated script, progress tracking based on progress of script generation and how well the generated script meets the conditional attributes, milestones, and/or defined goal. Validation system 410 can also perform a goal completion check to check whether all conditional attributes have been satisfied such that the generated script and analysis of the binary data satisfy the defined goal. In some embodiments, if validation system 410 determines that the defined goal has not been satisfied, validation system 410 can refine the goal for input to reverse engineering strategist 406 to update prompts for analysis pipeline 408 using a dynamic prompt update based on data transmitted from validation system 410.

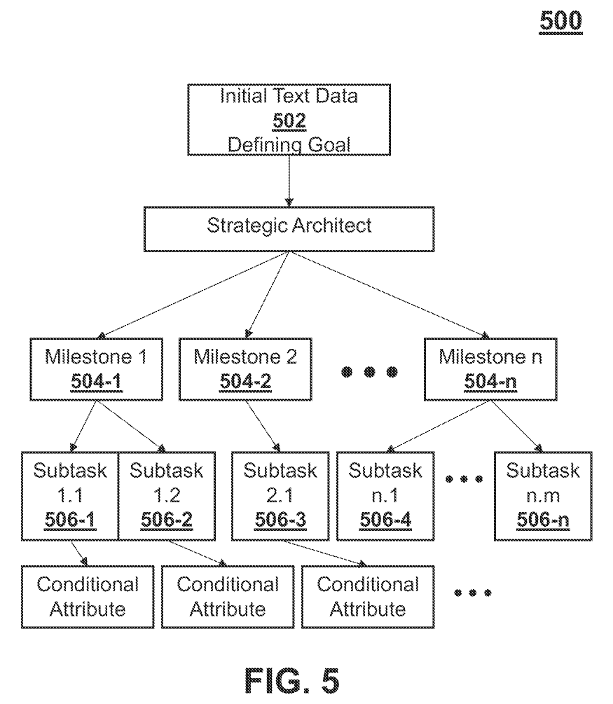

FIG. 5 shows a diagram of an exemplary strategic architect application 500 (e.g., the same as or similar to strategic architect 404) for decomposing a goal based on text input data defining the goal. FIG. 5 shows strategic architect application 500 receiving text input data 502 defining a goal. Strategic architecture application 500 can decompose the text input data defining the goal into plural milestones 504-1 to 504-n (referred to individually as milestone 504 and/or collectively as milestones 504 where appropriate) using a machine learning model (e.g., an LLM) with text input data 502 as input to the machine learning model. Strategic architect application 500 can decompose plural milestones 504 into subtasks 506-1 to 506-n (referred to individually as subtask 506 and/or collectively as subtasks 506 where appropriate). Each subtask 506 can be associated with at least one conditional attribute, such that the subtask can be considered to be a completed subtask when the at least one conditional attribute is satisfied. Once all subtasks 506 (e.g., subtasks 506-1 and 506-2) for a milestone 504 are complete, that milestone 504 (e.g., milestone 504-1) can be considered complete and can be validated as part of validating the defined goal based on the initial text data 502.

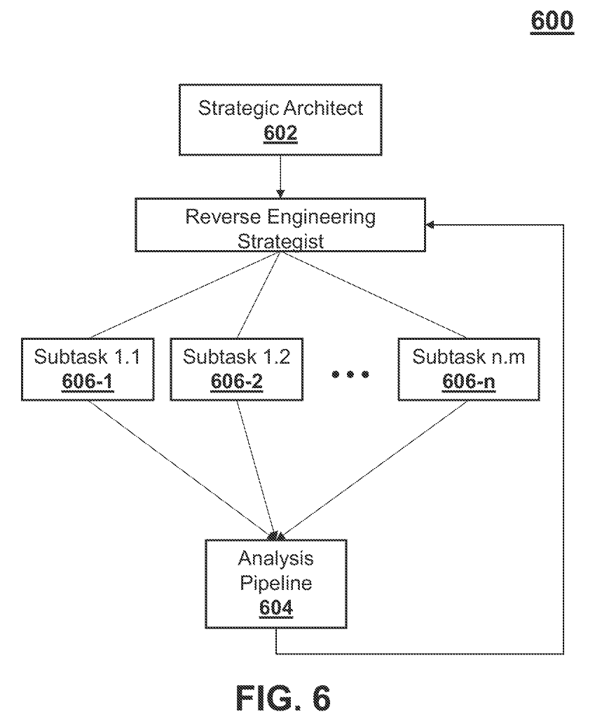

FIG. 6 shows a diagram of an exemplary reverse engineering strategist application 600 (e.g., the same as or similar to reverse engineering strategist 406) for managing a reverse engineering analysis of binary data. For example, reverse engineering strategist application 600 can receive a goal structure (e.g., a mapping of a goal into milestones, subtasks, and/or conditional attributes) from strategic architect 602 (which can be the same or similar to strategic architect 404 and/or strategic architect 500). Once reverse engineering strategist 600 receives the goal structure, reverse engineering strategist 600 can send a first subtask (e.g., subtask 606-1) to analysis pipeline 604 to begin analyzing whether at least one conditional attribute of the first subtask has been satisfied based on processor trace output and/or decompiled code. Reverse engineering strategist application 600 can receive results from analysis pipeline 604 after analysis pipeline 604 has performed a code analysis on the binary data (e.g., the processor trace output and/or decompiled code). Part of the code analysis performed by analysis pipeline 604 can include determining whether that iteration of the code analysis satisfied or did not satisfy the at least one conditional attribute. In some embodiments, analysis pipeline 604 can transmit a generated script to reverse engineering strategist application 600 as part of the results. In some embodiments, reverse engineering strategist application 600 can manage and/or transmit each subtask in a separate iteration, such that each subtask is analyzed in sequence. Alternatively, reverse engineering strategist application 600 can transmit all subtasks to analysis pipeline 604 to be analyzed in a batch.

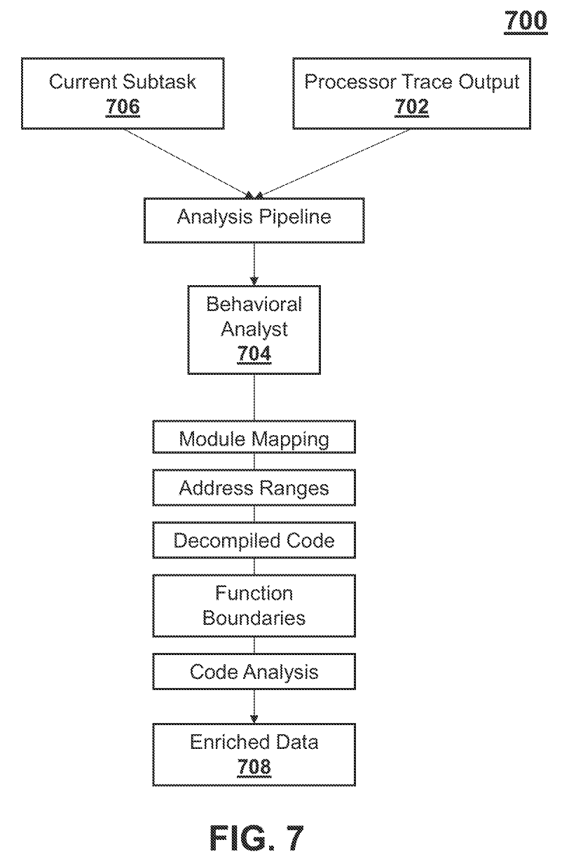

FIG. 7 shows a diagram of an exemplary analysis pipeline application 700 (e.g., the same as or similar to analysis pipeline 408 and/or analysis pipeline 604) for performing code analysis on binary data and generating results. Analysis pipeline application 700 can receive data for a current subtask 706 from a reverse engineering strategist application (e.g., reverse engineering strategist application 600). Analysis pipeline application 700 can also receive processor trace output 702 from a processor trace system (e.g., processor trace system 112) where a processor trace was executed on the binary data to determine one or more functions and/or one or more execution paths of the binary data.

Analysis pipeline application 700 can include behavioral analyst 704 which can receive current subtask 706 and processor trace output 702 for code analysis. Behavioral analyst 704 can include mapping modules and/or functions of processor trace output 702 to generate a module map. Behavioral analyst 704 can determine address ranges of the modules and/or functions that are included in the module map. Behavioral analyst 704 can correlate the address ranges with the modules and/or functions that can be included in the module map to generate mapped code output. Behavioral analyst 704 can correlate the mapped code output with decompiled code stored in a decompiled code database (e.g., malware and decompiled code database 110) to determine boundaries and entry code and/or exit code for the modules and/or functions. Behavioral analyst 704 can complete code analysis by generating enriched data 708 providing detailed information about the binary data based on analyzing the mapped code output, the decompiled code, and the mapped code output correlated with decompiled code. Enriched data 708 can include information about the binary data that can allow malware detection system 102 and/or an intelligent analysis application to generate scripts related to the binary data, such as scripts that can emulate/simulate the binary data and/or an aspect of the binary data. Enriched data 708 can include information such as network attributes of the binary data, execution details of the binary data, and/or other information. Once behavioral analyst 704 completes code analysis, behavioral analyst 704 can transmit enriched data 708 to an intelligent analysis application.

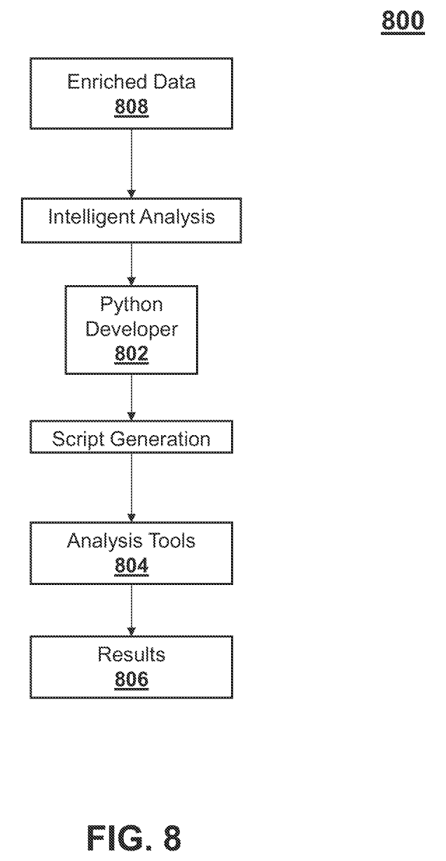

FIG. 8 shows a diagram of an exemplary intelligent analysis application 800 for performing code analysis on binary data and generating results, such as generating a script. Intelligent analysis application 800 can receive enriched data 808 (e.g., which can be the same or similar to enriched data 708 generated by analysis pipeline application 700) from a code analysis pipeline (e.g., analysis pipeline application 700). Intelligent analysis application 800 can transmit enriched data 808 to python developer 802 for developing and generating scripts. Python developer 802 can generate scripts (e.g., written in the Python^{TM} programming language) including source code (e.g., interpreted code), where the source code, when executed, can simulate/emulate at least one aspect of the binary data or at least one aspect associated with the binary data (e.g., a command and control server). Python developer 802 can transmit a generated script to analysis tools 804 for analyzing and/or executing the generated script. Analysis tools 804 can generate results 808 associated with the generated scripts, and analysis tools 804 can transmit results 808 back to a reverse engineering strategist application (e.g., reverse engineering strategist application 600) to determine whether at least one conditional attribute is satisfied by the generated script and/or results 808.

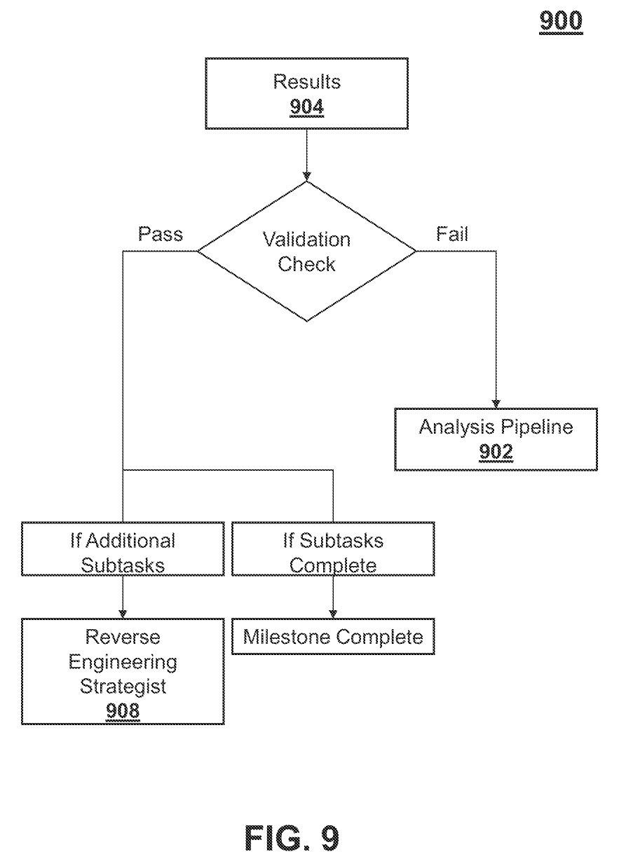

FIG. 9 shows a diagram of an exemplary validation application 900 for validating results of code analysis. Validation application 900 (which can be the same as or similar to validation system 410) can perform cache management of validation checks. For example, validation application 900 can cause memory (e.g., memory 108) can store previous validation results (e.g., from previous iterations) and validation application 900 can reference the previous validation results to speed up code analysis. In this way, validation application 900 can reduce and/or eliminate redundant work, further speeding up the validation code analysis process and the binary data reverse engineering process. Data from analysis can be stored in a database (e.g., malware and decompiled code database 110). When code analysis involving the same and/or similar attributes is performed by validation application 900, validation application 900 can retrieve validation results (e.g., previous validation results) results directly from cache memory and/or malware and decompiled code database 110.

Validation application 900 can perform validation checks based on receiving results (e.g., results 904) from an intelligent analysis application (e.g., intelligent analysis application 800) where the results can include a report and/or a generated script. Validation system 900 can validate the results by performing a validation check. For example, validation system 900 can validate results 904 by comparing a received report to at least one conditional attribute or validation system 900 can validate results 904 by performing test execution of a received generated script and by checking the test execution of the generated script against at least one conditional attribute.

As shown in FIG. 9, if results 904 pass the validation check, validation system 900 can check if additional subtasks and/or conditional attributes are required to be validated. If there are additional subtasks to be validated, then validation system can return results 904 to reverse engineering strategist application 908 (which can be the same as or similar to reverse engineering strategist 600) and transmit a request to reverse engineering strategist 908 for a next subtask to be analyzed to generate new results so that validation system 900 can validate the new results for the next subtask. As shown in FIG. 9, if results 904 pass the validation check, validation system 900 can check if additional subtasks are required or if all subtasks for a milestone are complete. Where validation system 900 determines that all subtasks for a milestone are complete, validation system 900 can transmit a response to reverse engineering strategist 908 indicating that all subtasks have been successfully validated for a milestone and that the milestone is complete.

In some embodiments, validation system 900 can determine that results 904 have failed the validation check (e.g., that results 904 do not satisfy the at least one conditional attribute for a subtask). If validation system 900 determines that results 904 failed the validation check, validation system 900 can transmit a response indicating a failure to analysis pipeline 902 (which can be the same as or similar to analysis pipeline 700 and/or analysis pipeline 408). Where analysis pipeline 902 receives an indication that results 904 failed validation, analysis pipeline 902 can perform additional analysis for the current subtask (e.g., subtask 706) and/or perform an additional processor trace to generate new processor trace output for further analyzing the binary data, such that a subsequent analysis may satisfy the validation check and at least one conditional attribute. In this way, malware detection system can continually refine the analysis of binary data such that malware detection system can robustly satisfy conditional attributes defined by user text input, such that malware detection system 102 can speed up the process of reverse engineering binary data and use less resources that would be required to manually reverse engineer the binary data.

The number and arrangement of systems, hardware, and/or applications shown in FIGS. 4-9 is provided as an example. There may be additional systems, hardware, and/or applications, fewer systems, hardware, and/or applications, different systems, hardware, and/or applications, or differently arranged systems, hardware, and/or applications than those shown in FIGS. 4-9. Furthermore, two or more systems, hardware, and/or applications shown in FIGS. 4-9 can be implemented within a single system, hardware, and/or device. A single system, hardware, and/or applications shown in FIGS. 4-9 can be implemented as multiple, distributed systems, hardware, and/or applications. Additionally, or alternatively, a set of systems, a set of hardware, and/or a set of applications of FIGS. 4-9 can perform one or more functions described as being performed by another set of systems, another set of hardware, or another set of applications of FIGS. 4-9.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based CPU, a DSP, a GPU, a Field Programmable Gate Array (FPGA), etc. The hardware of such devices can be integrated onto a single substrate (e.g., silicon “die”), or distributed among two or more substrates. Various functional aspects of the processor can be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory; the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, RAM, ROM, Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can be accessed by the processor.

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium can store computer-executable instructions to be executed by a processing element and/or control logic, and data which is manipulated by a processing element and/or control logic, and can take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

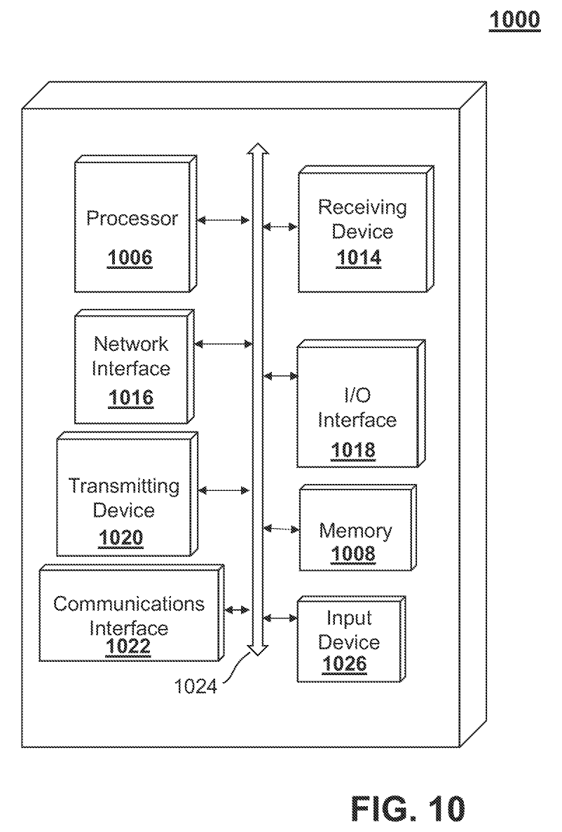

FIG. 10 shows a diagram of example components of a computing device or system 1000 as disclosed herein. Computing device 1000 (and/or at least one component of computing device 1000) can correspond to at least one of malware detection system 102, malware detection application 104, processor 106, memory 108, malware and decompiled code database 110, processor trace system 112, and/or command and control device 114 in FIG. 1 and/or at least one of malware detection system 302, computing device 304, client device 306, server 308, database 310, and/or communication network 312 in FIG. 3. In some embodiments, such systems or devices shown in FIGS. 1 and 3-9 can include at least one computing device 1000 and/or at least one component of computing device 1000. The number and arrangement of components shown in FIG. 10 are provided as an example. In some embodiments, computing device 1000 can include additional components, fewer components, different components, or differently arranged components than those shown in FIG. 10. Additionally, or alternatively, a set of components (e.g., one or more components) of computing device 1000 can perform one or more functions described as being performed by another set of components of computing device 1000.

Computing system or device 1000 can include processor 1006, memory 1008, receiving device 1014, network interface 1016, input/output (I/O) interface 1018, transmitting device 1020, communications interface 1022, communication infrastructure 1024, and input device 1026. Memory 1008 can be the same as or similar to memory 108 as disclosed herein. Processor 1006 can be the same as or similar to processor 106 as disclosed herein. Communications infrastructure 1024 can be the same as or similar to communication network 312.

Memory 1008 can be configured for storing program code for at least one machine learning model. Memory 1008 can include one or more memory devices such as volatile or non-volatile memory. For example, the volatile memory can include random access memory. According to exemplary embodiments, the non-volatile memory can include one or more resident hardware components such as a hard disk drive and a removable storage drive (e.g., a floppy disk drive, a magnetic tape drive, an optical disk drive, a flash memory, or any other suitable device). The non-volatile memory can include an external memory device connected to communicate with the system 1000 via a mobile communication network. According to an exemplary embodiment, an external memory device can be used in place of any resident memory devices. Data stored in system 1000 can be stored on any type of suitable computer readable media, such as optical storage (e.g., a compact disc, digital versatile disc, Blu-ray disc, etc.) or magnetic tape storage (e.g., a hard disk drive). The stored data can include network traffic data, log data, streaming events, and/or call detail records (CDRs) generated and/or accessed by processor 1006, and software or program code used by processor 1006 for performing the tasks associated with the exemplary embodiments described herein. The data can be configured in any type of suitable database configuration, such as a relational database, a structured query language (SQL) database, a distributed database, an object database, etc. Suitable configurations and storage types will be apparent to persons having skill in the relevant art.

Receiving device 1014 can be a combination of hardware and software components configured to receive data samples from the mobile network or database. According to exemplary embodiments, receiving device 1014 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. Receiving device 1014 can be an input device for receiving signals and/or data samples formatted according to 3GPP protocols and/or standards. Receiving device 1014 can be connected to other devices via a wired or wireless network or via a wired or wireless direct link or peer-to-peer connection without an intermediate device or access point. The hardware and software components of receiving device 1014 can be configured to receive the data from the mobile network according to one or more communication protocols and data formats. For example, receiving device 1014 can be configured to communicate over a network, which can include a LAN, a WAN, a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, receiving device 1014 can be configured to identify parts of the received data via a header and parse the data signal and/or data packet into small frames (e.g., bytes, words) or segments for further processing at processor 1006.

Processor 1006 can be configured for executing the program code stored in memory 1008. Upon execution, the program code can cause processor 1006 to perform the functions on at least one node within the mobile communication network and/or a remote computing device (e.g., server, computer, etc.) within the mobile communications network according to exemplary embodiments described herein. Processor 1006 can be a special purpose computing device encoded with program code, software, and/or firmware or a general purpose computing device configured to read program code or software from memory 1008 to execute the program code or software for performing the exemplary functions and/or features disclosed herein. According to exemplary embodiments of the present disclosure, processor 1006 can include a CPU. The CPU can be connected to the communications infrastructure including a bus, message queue, network, or multi-core message-passing scheme, for communicating with other components of computing system 1000, such as memory 1008, input device 1026, communications interface 1022, and I/O interface 1018. The CPU can include one or more processors such as a microprocessor, microcomputer, programmable logic unit or any other suitable hardware computing devices as desired.

I/O interface 1018 can be configured to receive a signal from processor 1006 and generate an output suitable for a peripheral device via a direct wired or wireless link. I/O interface 1018 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

Transmitting device 1020 can be configured to receive data from processor 1006 and assemble the data into a data signal and/or data packets according to the specified communication protocol and data format of a peripheral device or remote device to which the data is to be sent. Transmitting device 1020 can include any one or more of hardware and software components for generating and communicating the data signal over communications infrastructure 1024 and/or via a direct wired or wireless link to a peripheral or remote device. Transmitting device 1020 can be configured to transmit information according to one or more communication protocols and data formats as discussed in connection with receiving device 1014.

According to exemplary embodiments described herein, memory 1008 and processor 1006 can store and/or execute computer program code for performing the specialized functions described herein. It should be understood that the program code can be stored on a non-transitory computer usable medium, such as memory devices for the system 1000 (e.g., computing device), which can be memory semiconductors (e.g., DRAMs, etc.) or other tangible non-transitory means for providing software to system 1000. The computer programs (e.g., computer control logic) or software can be stored in memory devices (e.g., device memory 1008) resident on/in system 1000. The computer programs can also be received from external storage devices and/or network storage locations via a communications interface. Such computer programs, when executed, can enable system 1000 to implement the present methods and exemplary embodiments discussed herein. Accordingly, such computer programs can represent controllers of system 1000. Where the present disclosure is implemented using software, the software can be stored in a computer program product or non-transitory computer readable medium and loaded into system 1000 using any one or combination of a removable storage drive, an interface for internal or external communication, and a hard disk drive, where applicable.

In the context of exemplary embodiments, a processor can include one or more modules or engines configured to perform the functions of the exemplary embodiments described herein. Each of the modules or engines can be implemented using hardware and, in some instances, can also utilize software, such as corresponding to program code and/or programs stored in memory. In such instances, program code can be interpreted or compiled by the respective processors (e.g., by a compiling module or engine) prior to execution. For example, the program code can be source code written in a programming language that is translated into a lower level language, such as assembly language or machine code (e.g., binary data), for execution by the one or more processors and/or any additional hardware components. The process of compiling can include the use of lexical analysis, preprocessing, parsing, semantic analysis, syntax-directed translation, code generation, code optimization, and any other techniques that can be suitable for translation of program code into a lower level language suitable for controlling system 1000 to perform the functions disclosed herein. In some embodiments, pre-compiled program code (e.g., binary data) can be executed by a processor that did not compile the binary data. In such embodiments, the pre-compiled program code can be malicious program code. It will be apparent to persons having skill in the relevant art that such processes result in system 1000 being a specially configured computing device uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A system for detecting malware in a computer network, comprising:
at least one computing node having memory storing program code for a malware detection application and a processor trace system and having a processor for identifying malware, the processor configured to communicate with the memory and execute the program code for the malware detection application, wherein the program code for the malware detection application, when executed, will cause the processor to:
receive a binary data stream;
execute a processor trace on the binary data stream to dump processor trace data to the memory using the program code for the processor trace system;
identify a network attribute associated with the binary data stream based on the processor trace data;
extract the network attribute from the binary data stream;
generate a script for identifying and intercepting a beacon transmission used to transmit malware data, wherein the script is generated based on the network attribute; and
intercept reception of the beacon transmission and malware data within the computer network.

2. The system of claim 1, wherein the program code for the malware detection application, when executed, will cause the processor to:
execute the script to identify the beacon transmission; and
store data for the beacon transmission and the network attribute in a malware database for detection of the beacon transmission within the computer network.

3. The system of claim 1, wherein the program code for the malware detection application, when executed, will cause the processor to:
generate decompiled program code based on the binary data stream, wherein the binary data stream includes compiled program code;
identify a first offset and a last offset for each of plural functions in the processor trace data; and
correlate the first offset and the last offset of each of the plural functions to the decompiled program code.

4. The system of claim 1, wherein the system for detecting malware in a computer network includes plural computing nodes within the computer network.

5. The system of claim 1, wherein the network attribute associated with the binary data stream includes any one of a cryptographic key used to encrypt a message with the binary data stream, an internet protocol (IP) address, a port, a transport protocol, a cryptographic library, and a hypertext transfer protocol (HTTP) certificate.

6. A method for detecting malware in a computer network, the method comprising:
receiving a data stream of binary data representing a malware file at a network node;
identifying a network attribute associated with the data stream of binary data and the malware file;
extracting the network attribute to generate a script for identifying and intercepting a beacon transmission used to transmit malware data; and
intercepting the beacon transmission and malware data within the computer network.

7. The method of claim 6, wherein identifying the network attribute includes:
generating at least one conditional attribute representing validation criteria for a task to be satisfied, wherein the at least one conditional attribute is validated by executing the script which includes the network attribute; and
wherein extracting the network attribute includes:
executing the script for test execution to validate the at least one conditional attribute, wherein the script satisfies the at least one conditional attribute; and
storing the script in a detection database for malware detection based on satisfying the at least one conditional attribute.

8. The method of claim 6, wherein identifying the network attribute and extracting the network attribute includes:
executing the binary data representing the malware file to trace processor instructions;
generating a processor trace output based on executing the binary data;
generating decompiled program code based on the binary data using a decompiling application; and
integrating the processor trace output with the decompiled program code to generate the script for identifying and intercepting the beacon.

9. The method of claim 7, wherein extracting the network attribute to generate the script includes, iteratively:
executing the script for test execution to validate the at least one conditional attribute, wherein the script does not satisfy the at least one conditional attribute;
updating instructions for generating the script based on the at least one conditional attribute; and
regenerating the script.

10. The method of claim 6, wherein the script includes program code configured for a command and control server associated with the malware file.

11. The method of claim 8, wherein the decompiling application includes program code for Ghidra; and
wherein integrating the processor trace output with the decompiled data includes:
identifying a first offset and a last offset for each of plural functions in the processor trace output;
mapping each function to output from Ghidra using the first offset and the last offset for each function.

12. The method of claim 7, wherein generating the at least one conditional attribute is performed by a large language model (LLM) based on text input defining the validation criteria for a task.

13. A system for detecting malware in a computer network, comprising:
memory storing program code for a binary decomposition application;
a database storing conditional attributes defining successful decompiling of binary program code; and
a processor for decompiling binary program code configured to communicate with the memory and execute the program code for the binary decomposition application, wherein the program code for the binary decomposition application, when executed, will cause the processor to:
receive a binary file including binary program code;
receive text input data which defines a goal of reverse engineering the binary file;
automatically decompose the text input data into one or more conditional attributes for validating a task associated with reverse engineering the binary file;
iteratively:
generate a processor trace output by executing the binary file while tracing instructions of the processor;
map the processor trace output to decompiled code output to generate a source code file based on the binary file;
determine that the source code file satisfies at least one conditional attribute of the one or more conditional attributes; and
detect at least one malware beacon based on the source code file.

14. The system of claim 13, wherein when the program code for the binary decomposition application causes the processor to determine that the source code file satisfies the at least one conditional attribute, the program code for the binary decomposition application will cause the processor to:
execute the source code file for test execution to validate the at least one conditional attribute, wherein executing the source code file satisfies the at least one conditional attribute; and
store the source code file in a malware database for malware analysis based on satisfying the at least one conditional attribute.

15. The system of claim 13, wherein the binary file including binary program code includes program code for malware.

16. The system of claim 13, wherein the source code file includes program code for a command and control server.

17. The system of claim 13, wherein when the program code for the binary decomposition application causes the processor to automatically decompose the text input data, the program code for the binary decomposition application will cause the processor to:
input the text input data to at least one large language model (LLM);
generate, with the LLM, one or more milestones associated with the goal of reverse engineering the binary file defined by the text input data, where each milestone is defined by text data; and
generate, with the LLM, the one or more conditional attributes based on providing the one or more milestones as input to the LLM, wherein the one or more conditional attributes include Boolean expressions for validating a task associated with a milestone.

18. The system of claim 13, wherein when the program code for the binary decomposition application causes the processor to map the processor trace output to the decompiled code output to generate the source code file, the program code for the binary decomposition application will cause the processor to:
identify a first offset and a last offset for each of plural functions in the processor trace output; and
correlate each function to the decompiled code output using the first offset and the last offset for each function.

19. The system of claim 13, wherein the decompiled code output is stored in a decompiled code database.

20. The system of claim 13, wherein the source code file includes a script that, when executed by the processor, causes the processor to simulate a communication message of program code for malware.
